(19) United States
(12) Patent Application Publication
(10) Pub. No.: US 2003/0084462 A1
(43) Pub. Date: May 1, 2003

(54) Digital boradcast reception device and method thereof, and printing device and method thereof

(76) Inventors: Junichi Kubota, Amagasaki-shi (JP); Kazuyuki Murata, Kyotanabe-shi (JP); Satoshi Tsujimura, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/278,813

(22) Filed: Oct. 24, 2002

(30) Foreign Application Priority Data
Oct. 26, 2001 (JP) 2001-329873

(51) Int. Cl. H04N 7/173; H04N 7/16

(52) U.S. Cl. 725/153; 725/141; 725/133

(57) ABSTRACT

A digital broadcast reception device comprises: a broadcast receiving unit 11 that receives a digital broadcast; a TS processing unit 12 and a decode unit 14 that separate video contents and data contents from the received digital broadcast; a image memory unit 15 that stores the separated video contents and data contents in a special-purpose plane and memorizes the separated video contents and data contents temporarily; an image output unit 16 that synthesizes the video contents and data contents stored in the image memory unit 15, generates image data, and output the image data; a remote control 26, an operation reception unit 13, and a processing control unit 20 that acquire a print instruction from an operator; and a print image generation unit 18 that selects and synthesizes the video contents and data contents stored in the image memory unit 15, generates a print data, and outputs the generated print data to a printer 30 in response to the print instruction.

### BACKGROUND OF THE INVENTION

(1) Field of the Invention

The present invention relates to printing digital contents, and especially to digital broadcast printing to print based on a digital broadcast signal received as a digital broadcast, and digital contents printing to print after storing received data temporarily as a digital broadcast.

(2) Description of the Prior Art

In recent years, a digital television broadcast is starting nationwide, and a mechanism that distributes various digital contents widely to households is being built. As for subject matter of the contents, a text, a still image, and a large volume of video are becoming distribution subjects.

Conventionally, some teletext broadcast programs are already practically applied, but the distribution subjects are the text, graphics that represents a simple graphic expression in a specification of NAPLPS and so forth.

As for printers to print the digital contents, a color video printer that prints a television broadcast screen and a personal computer printer linked to a personal computer connected to Internet (hereinafter referred to as a PC printer) are the representative examples.

To print a television image of various standards like NTSC, PAL, SECAM, HDTV and so forth as-is, it is necessary to receive a video frame refreshed at the rate of 50 Hz or 60 Hz before printing. Conventionally, to print television images, a printer called a color video printer is used. As for the color video printer, for example, NV-MPX5S, NV-MP50 and so forth produced and distributed by Matsushita Electric Industrial Co., Ltd. can be cited.

The color printer receives an analogue signal of a television image, stores image data acquired by A/D conversion, and prints the image data.

Recently, it is obvious that a method that process digital broadcast information digitally by a printer described in the Japanese Laid-Open Patent Application No. 2001-111923 (applicant: Sony Corporation) is known.

On the other hand, as for a printer that is linked to a personal computer, a user specifies a network address (URL), gets a page description that is received based on TCP/IP protocol and is described in HTML language from an outside site specified by the network address, has the page description interpreted by a program called an Internet browser and has the page description displayed on a screen. By the user's instruction, after the personal computer changes the page description into a two-dimensional layout description using a special printing program, the personal computer translates the page description to the printer control language, transmits the translated page description to the linked printer, and gets a printing result.

In this case, a program called a page layout program, which converts the page description to a two-dimensional layout, does a layout process for a control character (a control code that has a printer print characters from the head of the next line and that may be a single code like a line feed or a combination of plural codes like CR or LF) in response to a “control character instruction” command if the page description language has a “control character instruction”. In other cases also, the program generates a printing screen by automatic carriage return-line feeds if necessary. For example, the program lays out two-dimensionally because of a printing paper, to avoid laying a text out over the width of the printing paper, controls to process an automatic carriage return-line feed in the text when the text continues over the specific width.

Conventional teletext broadcast has almost three forms: a screen with video only on it; a graphics screen of teletext broadcast; and a screen with subtitles superimposed on video. Contrary to this, in new digital television broadcast, unconventionally, various contents like a text, graphics, a still image, and moving image contents connected to main video are broadcasted. As a result, display screens become various because of the combination between contents and media.

There are various screens, for example, an independent main video screen, a table of contents screen in which digital contents are selected, EPG (Electric Program Guide) screen that shows a list of programs, tiled windows of a main video screen and data broadcast screen associated with the main video (program association service), tiled windows of a main video screen and an independent data broadcast (independent service), and a screen of an independent data broadcast and so forth.

Under the circumstances, in response to the combinations between various contents and screen patterns, although there is a need to print the screens according to a user's intention, it is difficult by the conventional technology. Hereinafter, challenges and requirements occur when they are individually mentioned.

For a start, as the first challenge and requirement, there is a need to answer the request to select or specify printing subjects and to print video combined or synthesized freely in response to the various broadcast services.

In other words, there are following requests to print not only a whole screen but for example a partial screen limited to video parts, to print both of video and additional information (a image excluding program video) in the case of program association service, to print video and additional information selectively in the case of independent service, to control the printing subjects at the side of contents creator, to further realize them at a low cost, and to instruct the operations easily using a remote control.

For example, the conventional video printer conforming to the teletext broadcast can print the whole screen only. Conventionally, printing either a teletext broadcast that is made of a graphic screen only or a video screen on which subtitles are superimposed, is a printing subject, therefore the conventional video printer was good enough. But in the new digital television broadcast, a screen of new data broadcast service that lays out video on a partial screen and data information on a partial screen is broadcast. According to a program and operational situation, there is the case that a user wants to print only video information in the screen, but it is not realized by the conventional method.

Additionally, in the case that data of recipe associated with a cooking program is broadcast, on the contrary, there can be a requirement that only the data broadcast part of a recipe excluding the program of the present video is printed, but it is difficult to do this by the conventional method.

Furthermore, in the case that a screen is generated by combining graphics generated based on the received data contents, it is impossible to print the screen with high fidelity.

In digital broadcast, there is a case that video and contents associated with the video are distributed, and in that case, it is necessary to print the both in one screen to increase customer convenience.

Since printing unnecessary parts uses up paper and ink at a printer of a terminal and makes the printing time longer, it is great merit to limit the printing area properly for a user.

Next, as the second challenge and requirement, it is necessary to realize an outstanding printing operational function to enable the user to print intended contents by an easy operation.

To be more specific, conventionally in the case that a video printer is connected to a display device such as a television and so forth and the screen print is done, an operator operates “a remote control of a television” and selects a channel and while he/she is watching a broadcast video, at the timing that the desired scene is displayed, he/she instructs to print by pushing the buttons of “a remote control of a video printer” this time.

In general, since print instructions of a video printer also has a sensitive function, namely, “scene selection” that selects a specific scene from the video broadcast on a time series, an operator has to operate the buttons and so forth directly. In the current situation that the print instruction mechanism that needs high operability like this is provided in different devices, to select the scenes to be printed whenever necessary while selecting channels becomes an extremely difficult task.

Additionally, in the case that a user connects a conventional video printer to a video recording device such as VCR and so forth and has the conventional video printer print the screen, after he/she decides the scene by operating VCR main body or a remote control and using a frame advance function, he/she instructs the printing by pushing the buttons of “a remote control of a video printer”. In this case, it is easier to select the scenes, still the operator has to operate buttons of the different devices separately, and therefore there is a problem in the operability. Additionally, in the case of printing while replaying, there is the same challenge as the former.

Furthermore, as the third challenge and requirement, there is a requirement to maintain the layout and so forth, and to enable a printer to print with fidelity conforming to a display image of the contents.

In other words, there is a printer to print Web information described in HTML in conventional personal computer environments, but there is no printer to print what describes broadcast contents by BML (Broadcast Markup Language) (Herein after referred to also as “Web expression”). Since the screen information described by ML (Markup Language) is usually displayed differently by the interpretation by the layout program, it is difficult to print the expression displayed on the screen with fidelity.

But there are strong needs to reflect the screen image of the broadcast contents to printing with fidelity. Especially, in the case that the layout of a display screen and that of printing are different, for example, in the case that the font of the printer does not have a specific size (in the case that the size of the display screen and that of the printing paper are different and so forth), since the layout program starts a new line automatically and forcibly, it may happen that the number of lines of the text is different from that of the screen display.

Additionally, as for a conventional television, only the screen is printed, and therefore it is impossible to print web contents that the screen does not hold. Moreover, in the case of printing in the personal computer environments, it is possible to specify web contents and to print the contents, but when the contents include video, it is impossible to print the video parts.

On the other hand, in the case of the data contents that are distributed by the digital broadcast, it is ordinary for the web contents described by BML format to include the video screen, and therefore there are needs for web printing including video contents.

Additionally, there are needs to print the language format contents offered newly by the digital broadcast with fidelity and easily in response to the user's request, but such technology does not exist conventionally.

Especially, in the case of printing a screen of data broadcast that partially includes video contents, depending on the provided character font, the display layout of the screen and the printing format can be largely different.

### SUMMARY OF THE INVENTION

In view of the foregoing situation, this invention is proposed. It is the object of this invention to provide a digital broadcast receiver, a printer and so forth that respond to a digital broadcast and can print a television screen and so forth based on a digital signal.

To be more specific, considering that in the method of using a conventional video printer, a screen image that is superimposed and synthesized is printed as-is, it is the first object of this invention to provide a digital broadcast receiver, the printer and so forth that retain video contents and data contents in different buffers in order to change a layout and a style of superimposition variously as circumstances demand, and can generate a print image flexibly in response to a print instruction.

Moreover, it is the second object of this invention to provide the digital broadcast receiver, the printer and so forth that can execute a channel operation and a printer operation continuously by only one operation device and, by doing this, have an outstanding operability to print a desired scene with reliability.

Furthermore, it is the third object of this invention to provide the printer and so forth that maintain a layout and so forth of a screen display, and can print with fidelity complying with a display image of contents.

To achieve the first object, the digital broadcast receiver according to the present invention is a digital broadcast receiver that receives a digital broadcast including video contents and data contents comprises: a reception unit operable to receive a digital broadcast; a separation unit operable to separate video contents and data contents from the received digital broadcast; a video contents memorizing unit operable to memorize the separated video contents temporarily; a data contents memorizing unit operable to memorize the separated data contents temporarily; a screen data output unit operable to distinguish an area for displaying the video contents and an area for displaying the data contents, to synthesize the video contents memorized in the video contents memorizing unit and the data contents memorized in the data contents memorizing unit, and to generate and output screen data; a print instruction acquisition unit operable to acquire an print instruction from an operator; a print data output unit operable to select or synthesize the video contents memorized in the video memorizing unit and the data contents memorized in the data contents memorizing unit, and to generate and output print data in response to the print instruction.

Here, it is acceptable for the print data output unit to output only video contents memorized in the video contents memorizing unit and to output only data contents memorized in the data contents memorizing unit in response to the print instruction.

Additionally, it is acceptable that the digital broadcast receiver further comprising: a print control information extraction unit to extract print control information that instructs a way of printing the contents from the received digital broadcast while the video contents and the data contents are outputted by the screen data output unit, wherein the print data output unit outputs the video contents memorized in the video contents memorizing unit and the data contents memorized in the data contents memorizing unit selectively based on the print control information.

By doing this, the video contents and the data contents are stored separately, and since the two contents are synthesized and printed or only one is printed selectively in response to an operator's instruction, it is possible to print flexibly, reflecting the operator's intension.

To achieve the second object, according to the present invention, a digital broadcast receiver that receives a digital broadcast and outputs print data comprising: a broadcast reception unit operable to receive a digital broadcast; a tuner unit operable to select a desired channel from the received digital broadcast; a video formation unit operable to form video information by taking out video of the selected channel from the digital broadcast; a print data output unit operable to output the formed video as print data in response to the instructions by buttons that are described later; a tuning button that instructs the tuner unit which channel should be selected; and a print button that instructs the print data output unit to output.

Here, it is acceptable that the tuning button and the print button are provided in one remote control for remote operation.

By doing this, since it is possible to execute channel selection and a printer operation by operating buttons using one operation device such as a remote control and so forth, a conventional and complicated print operation that an operator operates separately the buttons that a receiver and a printer are provided with, can be avoided and the desired scene is printed with reliability.

Moreover, to achieve the third object, the printer according to the present invention is a printer that executes printing on a paper in response to print data inputted from outside comprising: a reception unit operable to receive print data that includes a character string from outside; a first conversion unit operable to insert a carriage return-line feed to a character string in response to a carriage return-line feed character and to lay out in the case that the character string includes a carriage return-line feed character; a second conversion unit operable to insert a carriage return-line feed to a character string and lay out based on a position in a paper on which the character string is printed; a print unit operable to execute the printing of the character string in response to the layouts by the first and the second conversion unit; and a prohibiting unit operable to prohibit an operation of the second conversion unit in a predetermined case.

Here, it is acceptable for the prohibiting unit to prohibit the operation of the second conversion unit based on the operator's instruction or the control information contained in the print data.

By doing this, since a moving carriage return-line feed when a character string is printed in the printer is suppressed, a problem that the screen image and the print image are different because of an automatic carriage return-line feed is avoided, and it is possible to maintain the layout in the screen display and to print the contents with fidelity to the display image.

Incidentally, the present invention can be realized as a digital broadcast print method and a print method with the digital broadcast receiver and the printer as steps, and can be realized as a program including those steps. Additionally, the program not only can be stored in the ROM and so forth that the digital broadcast receiver and the printer are provided with but also can be put into circulation through a record medium such as CD-ROM and so forth and a transmission medium such as communication network and so forth.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a function block diagram that shows a structure of a digital broadcast printing system according to the embodiment of the present invention.

FIG. 2 is a block diagram that shows detailed structures of a decode unit and an image memory unit of the digital broadcast receiver.

FIG. 3 is a block diagram that shows a detailed structure of a print image generation unit.

FIG. 4 is a block diagram that shows a detailed structure of a processing control unit.

FIG. 5 is an outline view of a remote control.

FIG. 6 is a block diagram of a detailed structure of a printing control unit.

FIG. 7 is a flow chart that shows operation procedures of a digital broadcast receiver in print output.

FIG. 8 is a flow chart that shows operation procedures of a printer in print output.

FIG. 9 is a processing block diagram that shows a detailed function of a conversion processing unit in a print image generation unit of a digital broadcast receiver.

FIG. 10 is a flow chart that shows the relationship between operations of a conversion processing unit in a print image generation unit and instructions of an operator.

FIG. 11 is a diagram that shows a screen display example and print examples in the case of receiving data broadcast of a program association service.

FIG. 12 is a diagram that shows a screen display example and print examples in the case of receiving data broadcast of an independent service.

FIG. 13 is a diagram that shows examples of Web print to print a specific BML page in broadcast data described by BML.

FIG. 14 is a diagram that shows an LCD display and setting buttons provided to a front panel and so forth of a printer.

FIG. 15 is a flow chart that shows operation procedures of an automatic return control unit of a printer.

FIG. 16 is a diagram that shows print examples by processing of an automatic return control unit of a printer.

FIG. 17 is a flow chart that shows operation procedures of a display attribute control unit of a printer.

FIG. 18 is a diagram that shows print examples by processing of display attribute control unit of a printer.

FIG. 19 is a flow chart that shows a example to handle a text with a “non-display” attribute.

FIG. 20 is a diagram that shows a screen output example and a print output example in the case of printing a text with a “non-display” attribute as-is.

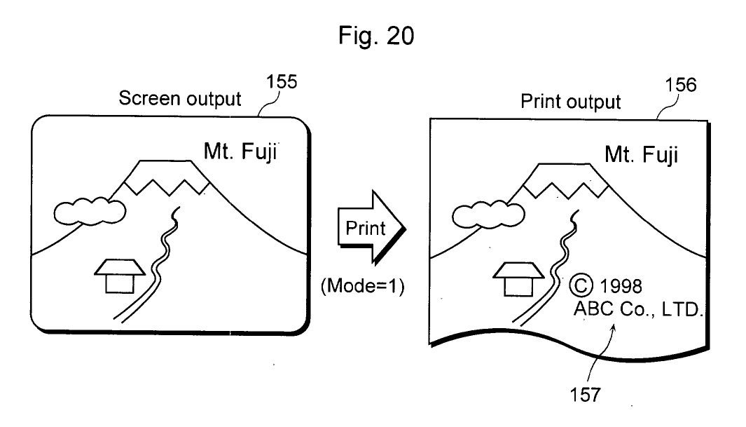

### DESCRIPTION OF THE PREFERRED EMBODIMENT(S)

The present embodiment of the present invention will be explained below with reference to the figures.

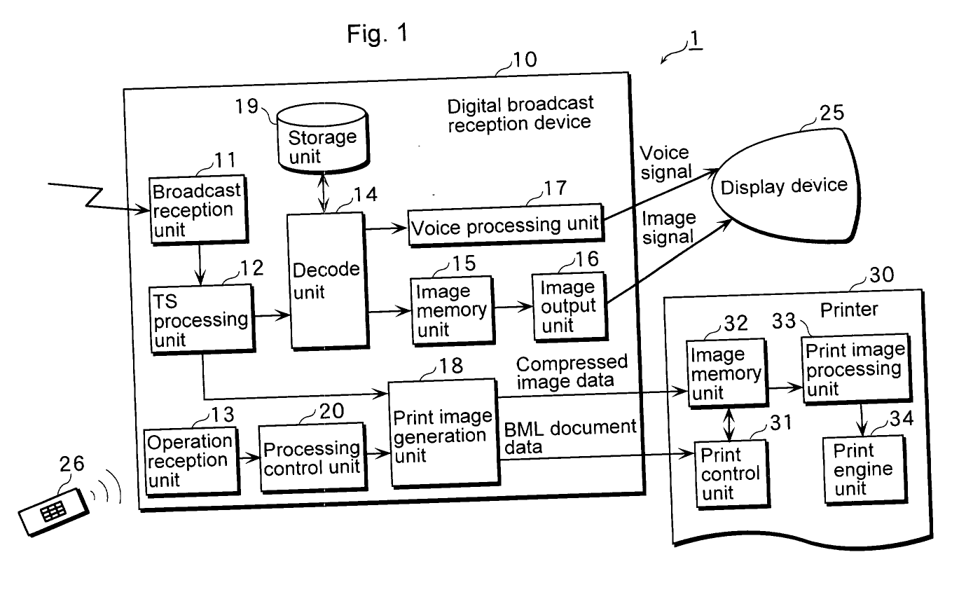

FIG. 1 is a function block diagram that shows a structure of digital broadcast printing system 1 according to the present embodiment. This digital broadcast printing system 1 is a system that receives digital broadcast, reproduces video and sound, and prints the video on printing papers. This digital broadcast printing system 1 comprises a digital broadcast receiving device 10, a display device 25, a remote control 26, and a printer 30. Incidentally, among these components 10, 25, 26, and 30, the digital broadcast receiving device 10, the display device 25, and the printer 30 can be housed in one case and can be realized as an integral-type television receiver or can be realized as a group of independent devices connected each other by special-purpose cables and so forth.

The digital broadcast receiving device 10 is a tuner device of a set top box (STB) and so forth. The digital broadcast receiving device 10 is a device that receives an electric wave of a digital broadcast, outputs a voice signal and an image signal to the display device 25 based on instructions and so forth from the remote control 26, and has the printer 30 print and output various images and texts. The digital broadcast receiving device 10 comprises: a broadcast receiving unit 11; TS processing unit 12; operation receiving unit 13; a decode unit 14; an image memory unit 15; a image output unit 16; a voice processing unit 17; a print image generation unit 18; a storage unit 19; a processing control unit 20; and so forth.

The broadcast receiving unit 11is a demodulation circuit and so forth that select an objective carrier from the received broadcast electric wave, and further reconstruct one TS (Transport Stream) by demodulation.

TS processing unit 12 is a TS decoder and so forth that descramble TS demodulated by the broadcast reception unit 11, and then demultiplex (separate) the TS into contents like a moving image (video), voice, data (a still image, characters, graphics, subtitles; hereinafter also referred to as “additional data”) and so forth, and pass the demutiplexed contents to a decode unit 14. An output at this moment is PES (Packetized Elementary Stream) and ES (Elementary Stream) before they are transformed into TS. Incidentally, in the case of a BML document acquired by demultiplexing, this TS processing unit 12 outputs the BML document also to the print image generation unit 18.

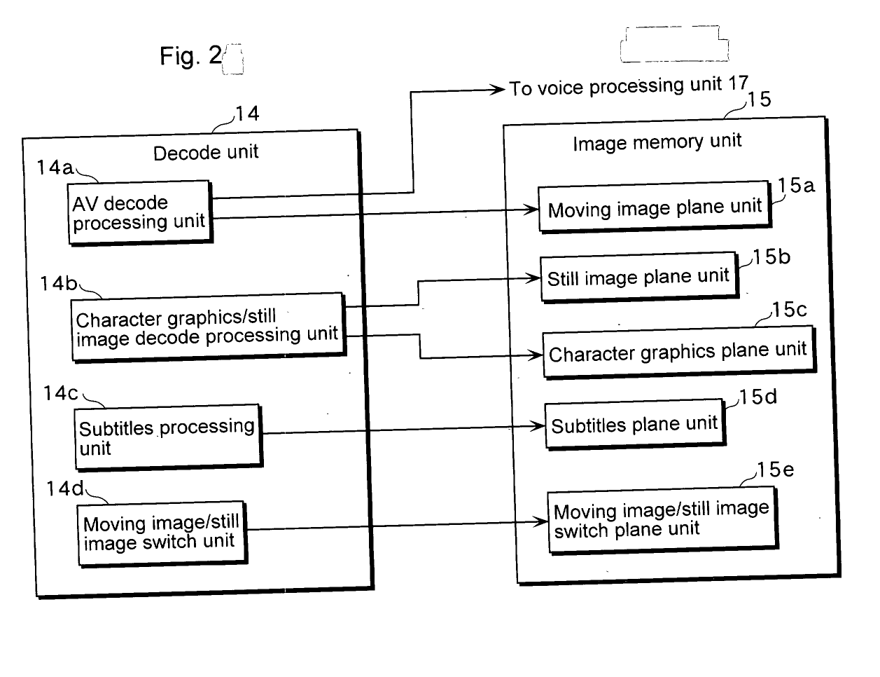

The decode unit 14 is a decoder and so forth that receive PES of voice, a moving image and data from the TS processing unit 12 and reconstruct the original stream of the voice, the moving image and the data from the received PES. As FIG. 2 shows, the decode unit 14 comprises: an AV decode processing unit 14a that reconstructs the original stream of the voice and the moving image from PES of the voice and the moving image; a character graphics still image decode processing unit 14b that reconstructs a character graphics still image from the data stream; a subtitles processing unit 14c that reconstructs subtitles from the data stream; and a moving image/still image switch unit 14d that reconstruct switch data that specifies, by the pixel unit, selection information indicating which of the moving image and the still image should be displayed, α value indicating a synthesis rate of various images and so forth.

Incidentally, “subtitles” in this case includes every character displayed that is superimposed on video. In other words, this “subtitles” includes not only “subtitles”, a service related with video but also “character superimposition”, another service.

The image memory unit 15 is a frame buffer and so forth that hold, by the frame unit, image data that unfold the images (a moving image, a still image, characters, graphics, and subtitles) that are outputted to the display device 25 and the printer 30. As FIG. 2 shows, the image memory unit 15 comprises: a moving image plane unit 15a that memorizes temporarily the moving image data outputted from the AV decode processing unit 14a; a still image plane unit 15b and a character graphics plane unit 15c that memorize temporarily the still image data and the character graphics respectively outputted from the character graphics still image decode processing unit 14b; a subtitles plane unit 15d that memorizes temporarily the subtitles outputted from the subtitles processing unit 14c; and a moving image still image switch plane 15e that memorizes temporarily the switch data outputted from the moving image/still image switch unit 14d.

The image output unit 16 is a synthesis circuit and so forth that synthesizes data of each image plane outputted from the image memory unit 15, converts the synthesized data into an analogue image signal like RGB and so forth, and outputs the analogue image signal to the display device 25. To be more specific, in response to the switch data in the still image plane unit 15b of the image memory unit 15, the image output unit 16 switches selectively the image data from the moving image plane unit 15a and the still image plane unit 15b; passes the image data; α synthesizes (transparently synthesizes) the image data from the character/graphics plane unit 15c and the subtitles plane 15d with the output data; decides the color and brightness of each pixel; and generate as an interlace image signal or a progressive image signal.

The voice processing unit 17 is a D/A converter and so forth, converts the voice stream outputted from the decode unit 14 into a voice signal, and outputs the voice signal to the display device 25.

The operation reception unit 13 receives an infrared radiation signal from the remote control 26, is a reception button circuit and so forth that acquire instructions from an operator through the push buttons and so forth on the front panel, and passes the acquired instructions to the print image generation unit 18 and so forth through the processing control unit 20.

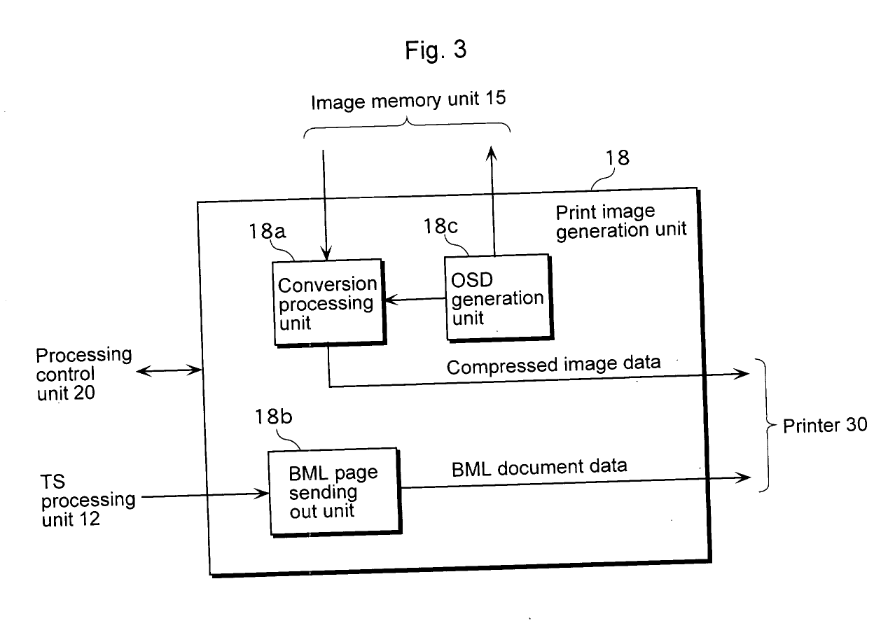

The print image generation unit 18 is a control circuit and so forth that generate two kinds of print data (compressed image data and/or BML document data), based on an operator's instructions and so forth sent from the processing control unit 20, to print and output the image that this digital broadcast receiver 10 has received to the printer 30. As FIG. 3 shows, the print image generation unit 18 further includes: the conversion processing unit 18a that does processing like reading out selectively the image data stored in the image memory unit 15, α synthesizing, adjusting the display position and the display size and so forth, and then outputs to the printer 30 as compressed image data exclusively for printing; a BML page sending out unit 18b that interprets the BML document data sent from the TS processing unit, cuts out only the BML page displayed on the display device 25 or document data of the BML page specified by an operator, outputs to the printer 30; and an OSD (On-Screen Display) generation unit 18c that converses with an operator through the remote control 26 and so forth, superimposes the frame (cursor) to specify the print object as an OSD on the screen of the display device 25, instructs the conversion processing unit to print and output the specified object.

The storage unit 19 is a hard disk, a DVD-RAM and so forth that store voice and image data outputted from the decode unit 14, records a broadcast complying with an instruction of an operator, and carries out a function as a buffer in a storage data broadcast.

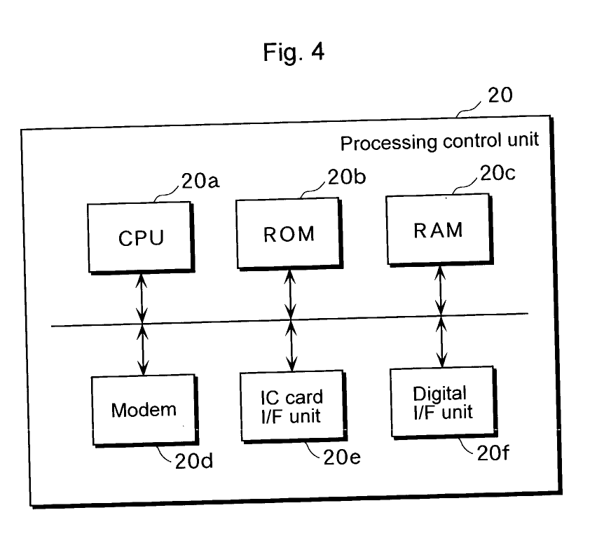

The processing control unit 20 controls the components 11˜19 of this digital broadcast receiver 10 based on an operator's instructions and so forth, and is a control unit that communicates with outside devices through a communication interface and so forth. As FIG. 4 shows, the processing control unit 20 comprises CPU 20a, ROM 20b that is a flash memory storing a control program, and so forth, RAM 20c, a modem 20d to connect with a telephone line and so forth, an IC card I/F unit to connect an IC card as a security module, a digital I/F unit 20f that is IEEE1394 to communicate with other devices at high-speed, and so forth. Incidentally, this processing control unit 20 also has a function that acquires various advance instruction information on printing (specification of plural print objects and so forth) from the operation reception unit 13, stores the instruction information temporarily in RAM 20c and so forth, in response to a request from the print image generation unit 18, send the instruction information sequentially to the print image generation unit 18.

The display device 25 is a television receiver or a monitor device with a speaker incorporated, based on the voice signal and the image signal, outputs voice from the speaker and displays video on the screen like CRT and so forth.

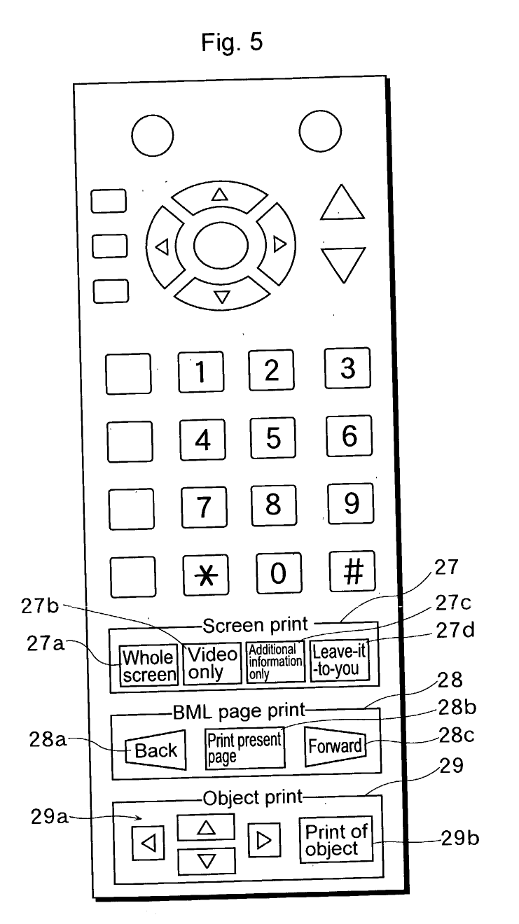

The remote control 26 is a remote control to operate the digital broadcast receiver 10 and the display device 25. As FIG. 5 shows, in addition to the buttons (a channel selector button) of an ordinary tuner remote control or a remote control for a television with a tuner incorporated, print buttons for printing images are provided.

To be more specific, the remote control 26 is provided with a group of screen print buttons 27 to have the printer 30 print selectively a screen image or part of it displayed on the display device 25 as a hard copy (hereinafter referred to also as “the screen print”); a group of BML page print buttons 28 to have the printer 30 print BML document data outputted from the TS processing unit 12 by the BML page unit (hereinafter referred to also as “Web print”); a group of object print button 29 to specify the print objects by the object (each still image, an rectangle area of character graphics, the specified video scenes stored in the storage unit19 and so forth) unit by the moves of a cursor displayed on the display device 25, and to have the printer 30 print the print objects.

Among the group of the screen print buttons, a “Whole screen” button 27a is a button to have the printer 30 print the screen image as-is, a “Video only” button 27b is a button to have the printer 30 print video only in the contents displayed on the screen, a “Additional information only” button 27c is a button to have the printer 30 print data contents, in other words, a still image, characters, graphics, and subtitles excluding the video, and a “Leave-it-to-you” button 27d to have the printer 30 print contents complying with a print instruction embedded in broadcast data.

Additionally, among the group of the BML page print buttons, a “Print present page” button 28b is a button to have the printer 30 print the BML document data displayed at the time by the page unit. A “Back” button 28a and an “Forward” button 28b are the buttons used in the case of reproducing and displaying the broadcast data stored in the storage unit 19. The “Back” button 28a is a button to transit (flip) in the direction to back to the pages displayed in the past by the page unit, while the “Forward” button 28c to transit in the direction to forward to newer pages.

Moreover, among the group of the object print buttons 29, arrow buttons 29a in the instructions from right to left and up and down are triggers to display the cursor that specifies the print object on the screen of the display device 25 and, at the same time, move the cursor, and specify the contents and the scenes in the case of reading out the contents stored in the storage unit 19. A “Print of objects” button 29b is a button to have the printer 30 print the object on which the cursor is located at the time.

By the remote control 26 like this, three kinds of groups of buttons, namely, the group of the screen print buttons 27, the group of the BML page print buttons 28, and the group of the object print buttons 29 are placed near the buttons to instruct the channel of a program, and therefore an operator can specify the print objects and starts the printing by easy operations of one device (the remote control 26) only by one hand. In other words, the operator can do a channel selection operation and a printer operation at hand consequently.

The printer 30 is a color inkjet printer and so forth to print and output the images received by the digital broadcast receiver 10 on a piece of ordinary paper. As FIG. 1 shows, the printer 30 comprises a print control unit 31, an image memory unit 32, a print image processing unit 33, and a print engine unit 34.

The image memory unit 32 is a buffer memory and so forth that memorize the images for printing temporarily, and hold compressed image data sent from the print image generation unit 18 of the digital broadcast receiver 10 and the image data sent from the print control unit 31. The image data sent from the print control unit 31 are what each object comprising the BML document data sent from the digital broadcast receiver 10 are unfolded.

The print image processing unit 33 is an image processing circuit and so forth that convert the image data for display stored in the image memory unit 32 into the image data for printing, and outputs the image data read out from the image memory unit 32 to the print engine unit 34 after expanding the image data if they are compressed and doing resolution conversion processing, color conversion processing, half-toning processing and so forth. Here, the resolution conversion processing is processing that converts the display resolution of the image signal and the image data generated by the digital broadcast receiver 10 into the print resolution of the printer 30. Additionally, the color conversion processing is a processing that converts RGB data and so forth for display into CMYK data and so forth for printing. Moreover, the half-toning processing is a processing that converts the image data stored in the image memory unit 32 into level of color that the print engine unit 34 can expresses.

The print engine unit 34 is a printer engine and so forth, and renders a color image or a monochrome image on an ordinary paper and so forth complying with the image data sent from the print image processing unit 33.

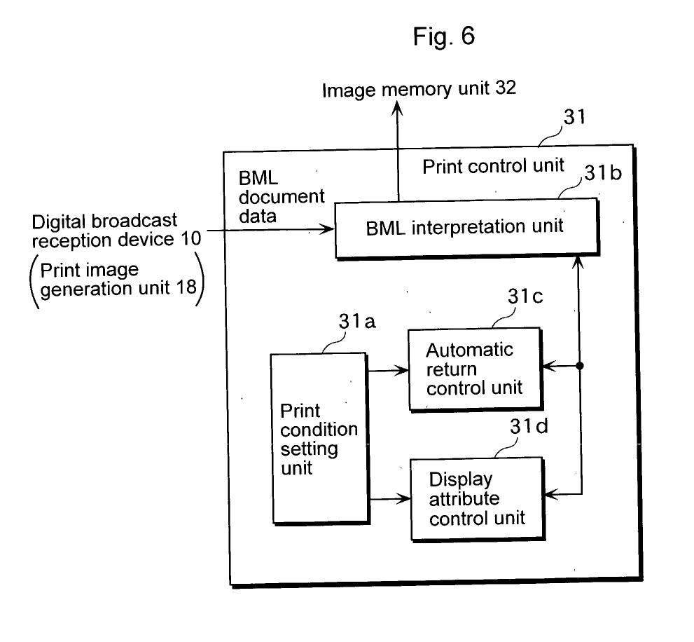

The print control unit 31 is a CPU and so forth that controls each component 32˜34 based on the BML document data sent from the print image generation unit 18 of the digital broadcast receiving device 10 and the instructions of an operator by the operation buttons provided with this printer 30. As FIG. 6 shows, the print control unit 31 comprises: a print condition setting unit 31a that acquires and holds the instructions for various settings by a conversation with an operator through the operation buttons; a BML interpretation unit 31b as a BML browser that interprets BML document data sent by the print image generation unit 18 of the digital broadcast receiver 10 by a synthetic analysis, unfolds to image data, and then write to the image memory unit 32; an automatic return control unit 31c that controls carriage return-line feed when characters and so forth are printed based on the size of papers set in this printer 30, and so forth; and a display attribute control unit 31d that does print control of characters in response to the display attributes (“display”/“non-display”) embedded in the image data and the BML document data sent by the print image generation unit 18 of the digital broadcast receiver 10.

Next, the operating characteristics of the digital broadcast printing system 1 that is composed as was stated above according to the present embodiment will be explained.

For a start, basic print operations by the present digital broadcast printing system 1 are explained.

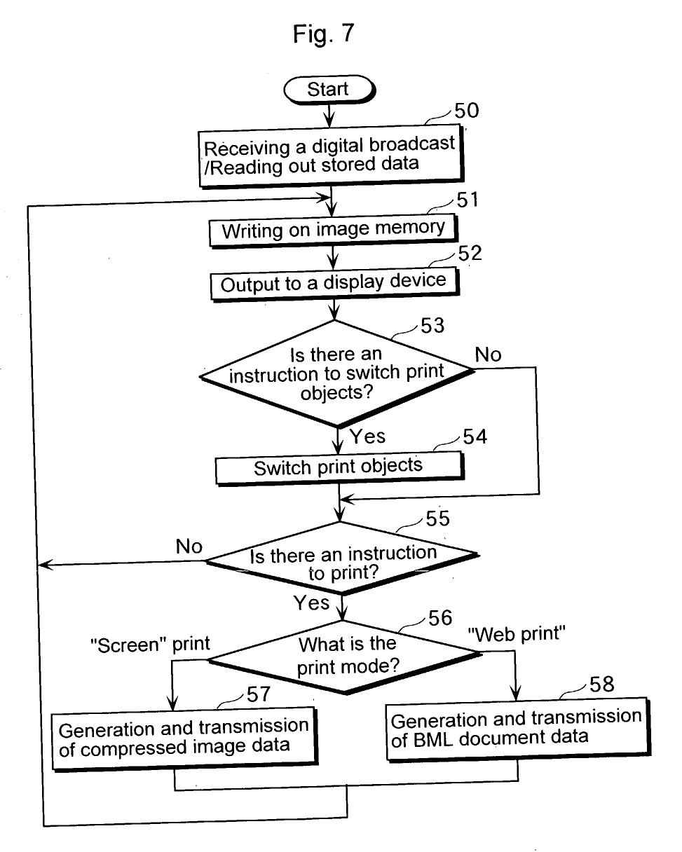

FIG. 7 is a flow chart that shows operation procedures of a digital broadcast receiver in print output. After images such as a moving image, a still image, characters, graphics, subtitles, are received by the broadcast reception unit 11 (or are read out by a storage unit 19) (Step 50), and the images are rendered and updated in the image memory unit 15 through the decode unit 14 and so forth (Step 51), the images are outputted as an image signal from the image output 16 and displayed on the display device 25 (Step 52). Then, whether the “Back” button 28a, the “Forward” button 28c, the arrow buttons 29a are operated by an operator, in other words, whether the operator issues an instruction to switch the print object or not is monitored (Step 53), when the switch instruction is issued, the new print object is specified (Step54). This processing such as the update of the image memory unit15, the display output, and the update of the print object (Step 51˜54) is repeated by frame rate until the print instruction from the remote control 26 (the group of the image print buttons 27 and the group of the BML page print buttons 28) is issued (Step 51˜55). When the print instruction by the remote control 26 is issued (Yes at Step 55), the print mode whether the print instruction is a “screen” print or “Web” print is judged (Step 56). As a result, in the case of the “screen” print by the group of the screen print buttons 27, the conversion processing unit 18a of the print image generation unit 18 freezes the update in the image memory unit 15, reads out the print object from the image memory unit 15, compresses after adjusting a position and a size, and outputs to the printer 30 as compressed image data (Step 57).

On the other hand, in the case that the print instruction is the “Web” print by the group of the BLM page print buttons 28, the BLM page output unit 18b of the print image generation unit 18 cuts out the page of BML document data corresponding to the displayed image at the time, in other words, in the BML document data acquired by the TS processing unit 12, the page displayed on the display device 25 at the time, or the page of BML document date specified by the operator as the print object, and outputs to the printer 30 (Step 58).

When the transmission of the compressed image data or the BML document data to the printer 30 has completed, the conversion processing unit 18a of the print image generation unit 18 cancels the frozen condition in the image memory unit 15, and restarts the processing such as rendering, display output and so forth of the image to the image memory unit 15 (Step 51˜55).

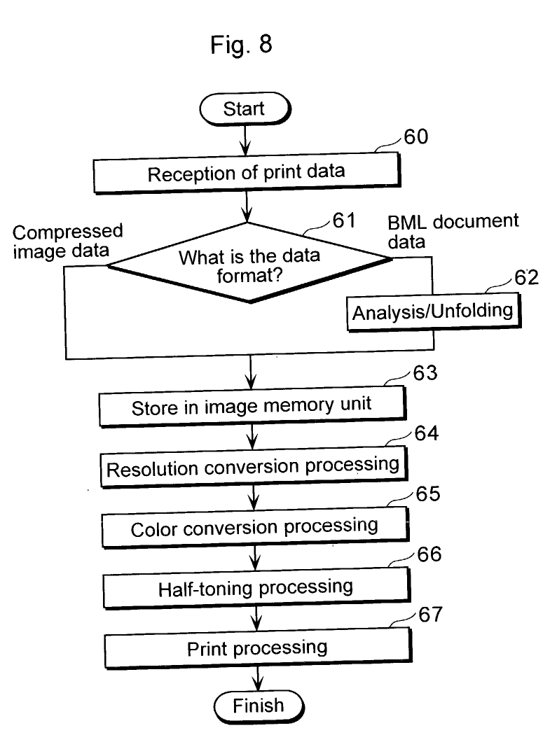

FIG. 8 is a flow chart that shows operation procedures of a printer 30 in print output. When the print data (the compressed image data or the BML document data) are transmitted from the digital broadcast receiver 10 to the printer 30 (Step 60), the processing corresponding to the type of the data is done. In other words, in the case that the print data are the compressed image data (“compressed image data” at Step 61), the data are stored as-is into the image memory unit 32 (Step 63). On the other hand, in the case of BML document data (“BML document data ” at Step 61), after the data are inputted into the print control unit 31 temporarily, are parsed in the BML interpretation unit 31b of the print control unit 31, and are unfolded into image data combining the each element (Step 62), the image data are written into the image memory unit 32 (Step 63).

Then, the print image processing unit 33 decompresses the image data stored in the image memory unit 32 if the image data are compressed, and then executes resolution conversion that converts the display resolution of the image data into that of the printer 30 (Step 64), executes color conversion processing that converts RGB data and so forth into CMYK data and so forth (Step 65), and executes the half-toning processing that converts the level of color in the condition that the print engine unit 34 can express. At last, the print engine unit 34 print a color image or a monochrome image on an ordinary paper and so forth by the ink jet method corresponding to the image data sent by the print image processing unit 33 (Step 67).

Next, selective print of broadcast contents and synthesized print of contents by the present digital broadcast printing system 1 are explained.

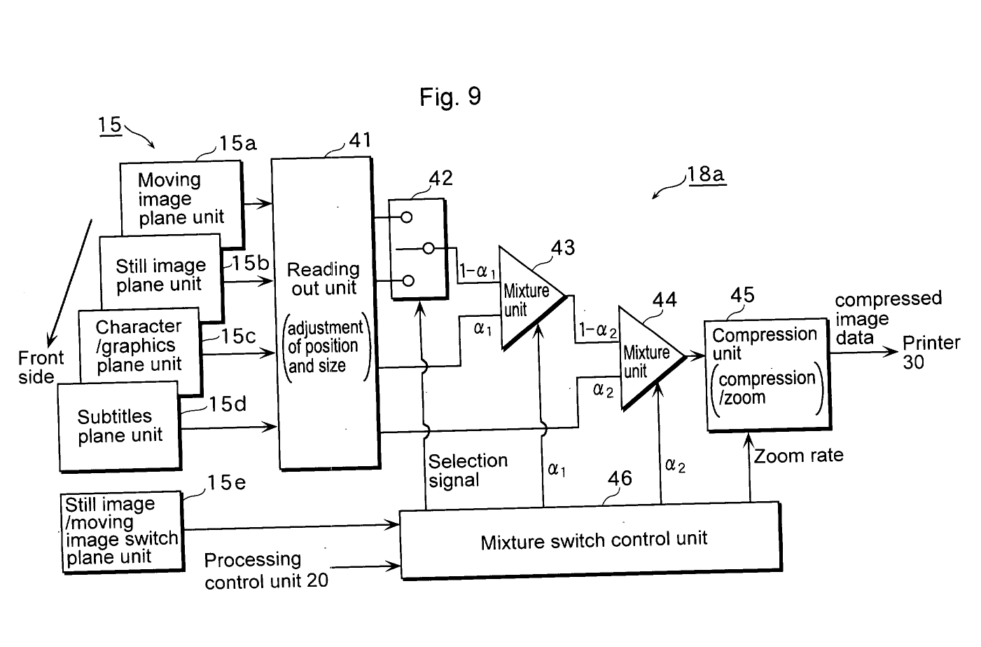

FIG. 9 is a processing block diagram that shows a detailed function of a conversion processing unit 18a in a print image generation unit 18 of a digital broadcast receiver 10. The conversion processing unit 18 comprises: reading out unit 41, a selector 42, mixture units 43 and 44, a compression unit 45, and a mixture switch control unit 46.

The reading out unit 41, based on the instructions and so forth of an operator from the processing control unit 20, reads out a moving image, a still image, character graphics, and subtitles rendered in each plane unit 15a˜15e at high speed by DMA transportation and so forth, and outputs each of them to the first input port and the second input port of the selector 42, the mixture units 43 and 44. At this time, the reading out unit 41, in response to an instruction from the processing control unit 20, adjusts the horizontal position and the vertical position of the image by displacing the timing when the reading out unit 41 reads out and outputs each image data by the pixel unit. Additionally, the reading out unit 41 enlarges or shrinks the size of the whole image by thinned-out processing and complementary processing of the read out image data by the pixel unit. By doing this, the print position and the size of each image type-by-type (object-by-object) are decided.

The selector 42, based on the selective instruction from the mixture switch control unit 46, lets either of image data from the moving image plane unit 15a or still image data from the still image plane unit 15b pass by the pixel unit.

The mixture units 43 and 44, based on the instruction (α value) from the mixture switch control unit 46, assign weights to and synthesize transparently the image data inputted from the two input ports. For example, in the case that α value indicates 30%, the mixture unit 43 generates the image data that assigns weights to the pixel value (RGB value and so forth) of the moving image data or the still image data inputted to the first input port from the selector 42, and the pixel value of the image data of the character graphics inputted to the second input port by 7 to 3, and synthesize.

The compression unit 45, by compressing and encoding one frame of the image data outputted by the mixture unit 44, generates the compressed data such as JPEG and so forth enlarged (or shrunk) by the zoom rate instructed by the mixture switch control unit 46, and outputs the compressed data to the printer 30 as the image data.

The mixture switch control unit 46, in response to the switch data that the mixture switch control unit 46 reads out from the moving image/still image switch plane 15e of the image memory unit 15; controls the selector 42, in response to an operator's instructions sent from the remote control 26 and so forth through the operation receiving unit 13 and the processing control unit 20, by outputting the selection signal, α 1 value, and α 2 value to the selector 42, the mixture units 43 and 44, respectively; outputs either one of the four types of the image selectively to the printer 30, outputs the image that is synthesized by combining and assigning weights freely to the printer 30; and enlarges or shrinks the ultimate image to fit the size of the printing paper of the printer 30.

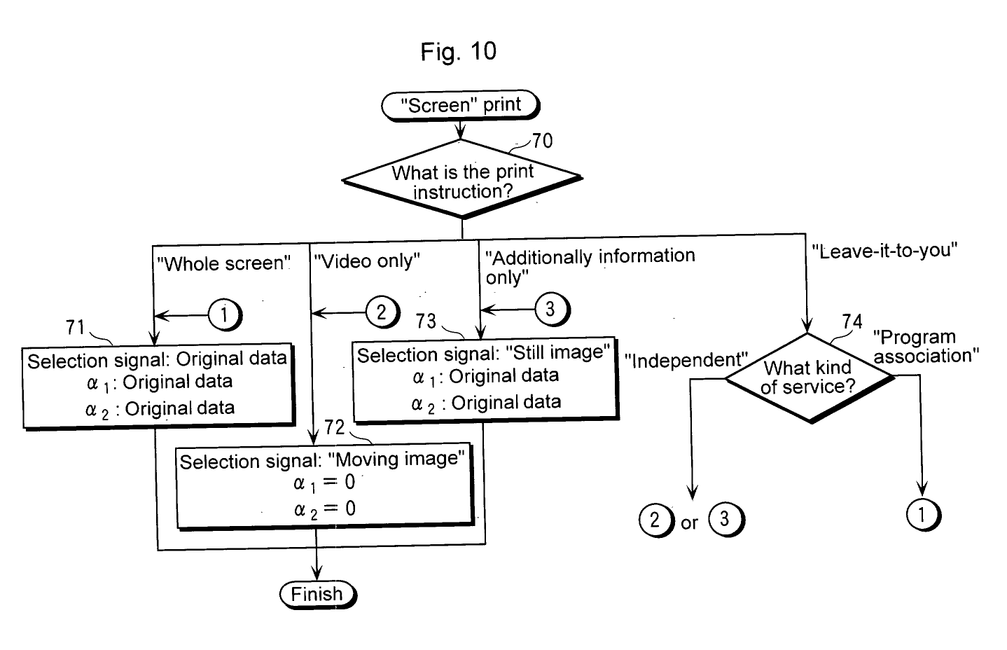

The relationship between the conversion processing unit that has such structure as this and the operator is shown in the flow chart of FIG. 10. In other words, in the case that the operator instructs a hard copy of “whole screen” by using the remote control 26 and so forth (“Whole screen” at Step 70), the reading out unit 41 reads out 4 types of the image data stored in the image memory unit 15, outputs the 4 types of the image data as-is to the selector 42 and so forth, without displacing the timing of the input and, at the same time, the mixture switch control unit 46 outputs a selection signal to the selector 42, and outputs α values (α 1 and α 2) to the mixture units 43 and 44 (Step 71). Accordingly, in this case, the compressed image data that is the same contents as the display image rendered in the image memory unit 15 is transmitted from the compression unit 45 to the printer 30, which prints and outputs.

On the other hand, in the case that the operator instructs to print “Video only” (“Video only” at Step 70), the reading out unit 41 reads out only the moving image data from the image memory unit 15 and outputs the moving image data to the selector 42 and, at the same time, the mixture switch unit control unit 46 outputs a selection signal that lets “moving image” pass to the selector 42, and outputs α values that indicate zero (α 1 and α 2) to the mixture units 43 and 44, respectively. Then, the compression unit 45 generates the compressed image data that fits (enlarges) the moving image sent to the compression unit 45 to the paper size of the printer 30, and outputs the compressed image to the printer 30 (Step 72). Accordingly, in this case, in the image displayed on the display device 25, only the image corresponding to the moving image is enlarged to the size of printing paper, transmitted to the printer 30, which prints and outputs.

Additionally, in the case that the operator instructs to print “Additional information only” (“Additional information only” at Step 70), the reading out unit 41 reads out all the data excluding the moving image data from the image memory unit 15, outputs to the selector 42 and so forth and, at the same time, the mixture switch control unit 46 outputs the selection signal that lets “the still image” pass to the selector 42, and outputs α values (α 1 and α 2) based on the switch data to the mixture units 43 and 44, respectively. Then, the compression unit 45 generates the compressed image data that fits (enlarges) the moving image sent to the compression unit 45 to the paper size of the printer 30, and outputs the compressed image to the printer 30 (Step 73). Accordingly, in this case, in the image displayed on the display device 25, only the image corresponding to the additional information excluding the moving image is enlarged to the size of printing paper, transmitted to the printer 30, which prints and outputs.

Additionally, in the case that the operator instructs to print “As-you-like-it” (“As-you-like-it” at Step 70), the print image generation unit 18, based on SI (Service Information) and so forth sent from TS processing unit 12, judges whether the data broadcast program that is now being received is an independent service or a program association service (Step 74). When it is judged to be the independent service, the reading out unit 41 and the mixture switch control unit 46, based on the advance settings, executes the same processing that the operator instructs to print “Video only” (Step 72) or the same processing that the operator instructs to print “Additional information only” (Step 73). On the other hand, when it is judged to be the program association service, the reading out unit 41 and the mixture switch control unit 46 executes the same processing that the operator instructs to print “Whole screen” (Step 71). Accordingly, in this case, the printing forms are dynamically decided according to the service forms that are being received. In other words, in the program association service in which the video is associated and displayed with the additional information, the video and the additional information in the tiled windows are printed with fidelity. On the other hand, in the independent service in which the video and the additional information are not associated, either the video or the additional information is printed in response to the operator's instructions.

Thus, the digital broadcast receiver 10 can output to the printer 30 not only the same screen image as the output to the display device but also the image data and the BML document data that show the special print contents to which the selection processing and the conversion processing are executed based on the operator's instructions and so forth, and therefore, it is possible to print and output complying with the various digital broadcast service.

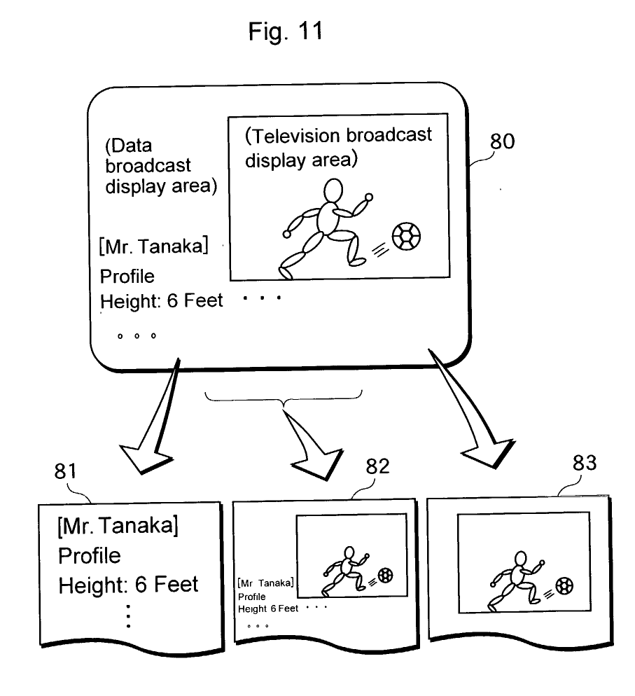

FIG. 11 shows a concrete print example like this by the conversion processing unit 18a of the print image generation unit 18, and here shows the relationship between the screen display and the print contents in the case that the data broadcast of a program association service is being received. Now, on the display device 25, a so called L-shaped screen 80 is displayed. In other words, on the right upper rectangle area of the screen (“Television broadcast display area”) the video of a broadcast program is displayed, and on the L-shaped area of the left and bottom parts of the screen (“Data broadcast display area”) the additional information related to the video of the broadcast program is displayed by character graphics.

The operator only has to push the “Whole screen” button 27a (or “Leave-it-to-you” button” 27d) among the group of the screen print buttons 27 of the remote control 26. Then, the compressed image data of the whole screen are transmitted from the print image generation unit 18 of the digital broadcast receiver 10 to the printer 30 and, as the print example 82 of FIG. 11 shows, the same image as the screen display of the display device 25 is outputted and printed. On the other hand, in the case that the operator wants to print only the additional information, he/she only has to push the “Additional information only” button 27c. Then, the compressed image data of the still image and the character graphics are transmitted from the print image generation unit of the digital broadcast receiver 10 to the printer 30, and as the print example 81 of FIG. 11 shows, only the additional information 81 displayed in the L-shaped area of the L-shaped screen is enlarged to the size of the printing paper and printed. Additionally, in the case that the operator wants to print the video of the broadcast, he/she only has to push “Video only” button 27b of the remote control 26. Then, the compressed image data of the moving image is transmitted from the print image generation unit 18 of the digital broadcast receiver 10, and only the video 83 displayed on the rectangle area of the right upper parts of the L-shaped screen 80, as the print example 83 of FIG. 11 shows, is enlarged to the size of the printing paper and is printed.

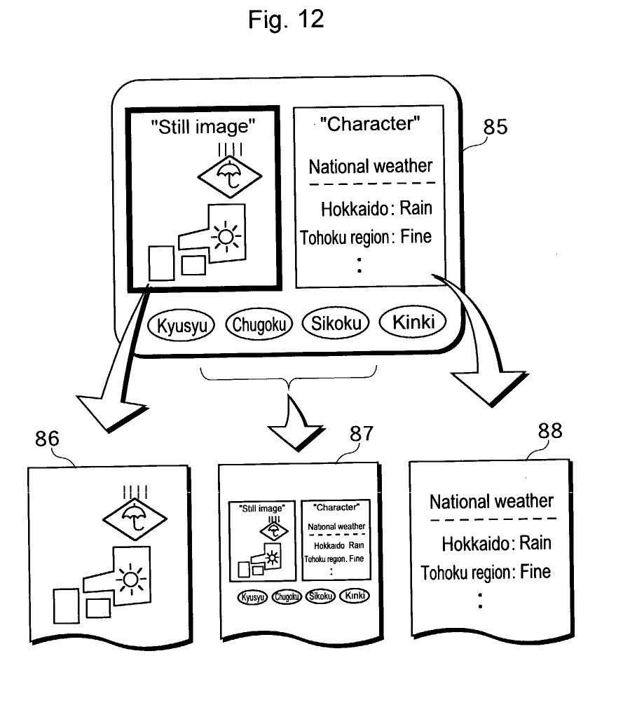

FIG. 12 shows one more specific print example by the conversion processing 18a of the print image generation unit 18, and here shows the relationship between the screen display and the print contents in the case that a data broadcast of the independent service. Now, on the display device 25, only the screen 85 of the independent service is displayed. In other words, on the left half of the screen 85, a still image such as “Japanese map” and so forth is displayed, and on the right half of the screen, character graphics such as “Weather forecast” and so forth are displayed.

The operator, in the case that he/she wants to print only the still image displayed on the screen 85, after he/she points the cursor (the thick black frame on the screen 85) displayed as OSD to the objective still image using an arrow button 29a and so forth of the group of the object print buttons 29 of the remote control 26, he/she only has to push the “Print of object” button 29b. Then, the compressed image data of only the still image are transmitted from the print image generation unit 18 of the digital broadcast receiver 10 to the printer 30, only the character graphics, as the print example 88 of FIG. 12 shows, are enlarged to the size of the printing paper and is printed. Incidentally, the operator, in the case that he/she wants to print everything displayed on the screen 85, he/she only has to push the “Whole screen” button 27a (or the “Leave-it-to-you” button 27d) of the group of the screen print buttons 27. Then, the compressed image data of the whole screen are transmitted from the print image generation unit 18 of the digital broadcast receiver 10 to the printer 30 and, as the print example 87 of FIG. 12 shows, the same image as the screen display of the display device 25 is outputted and printed.

Like this, in the case that the operator is receiving a program association service and so forth, and wants to print with fidelity the video associated and displayed with the additional information in the tiled windows, he/she only has to push the “Whole screen” button 27a or “Leave-it-to-you” button 27d of the remote control 26. Additionally, in the case that the operator is receiving a broadcast of the independent service and so forth and wants to print the video and the additional information selectively, he/she can select the desired object and print it by using the “Video only” button 27b, the “Additional information only” button 27c, the group of the object print buttons 29 and so forth.

Moreover, by using the group of the object print buttons 29, the operator can similarly select, output, and print one or plural pieces of the desired print scenes and objects of the video stored in the storage unit 19. For example, in the case that one title stored in the storage unit 19 is specified by the conversation with the operator through the remote control 26, and the print is instructed, the processing operation unit 20 instructs the print image generation unit 18 to read out a representative example of the title (for example, the first scene) from the storage unit 19, to output and to print, then the representative example of the video contents is outputted and printed.

Similarly, in the case that plural scenes are specified, after the video contents of these scenes are read out sequentially from the storage unit 19 and are processed to adjust the size and so forth in the print image generation unit 18, the video contents are transmitted to the printer 30, and are aligned and are printed on the printing paper. Additionally, by using the arrow buttons 29a also, it is possible to transition (transmit) the scenes stored in the storage unit 19 sequentially, print the scenes continuously, and print the scenes after skipping.

Incidentally, it is acceptable to add further special-purpose buttons that select the detailed types of objects to the group of the screen print buttons 17 of the remote control 26: for example, the button to print only the characters (text); the button to print only the still image; and the button to print only the subtitles and so forth. The selection of the print objects like these can be realized by the selection signal and the a value that the conversion processing unit 18a and the mixture switch control unit 46 output. Additionally, it is acceptable to print, by using the arrow buttons 29a and so forth of the remote control 26, not by the unit of the types of the objects (the moving image, the still image, and so forth) but by the unit of each object by moving and specifying the each subject by the cursor. Then, it is acceptable that the mixture switch control unit 46 and the compression unit 45 of the conversion processing unit 18a automatically adjust the zoom rate or the operator specifies the zoom rate so that the size of the print object fits the printing paper.

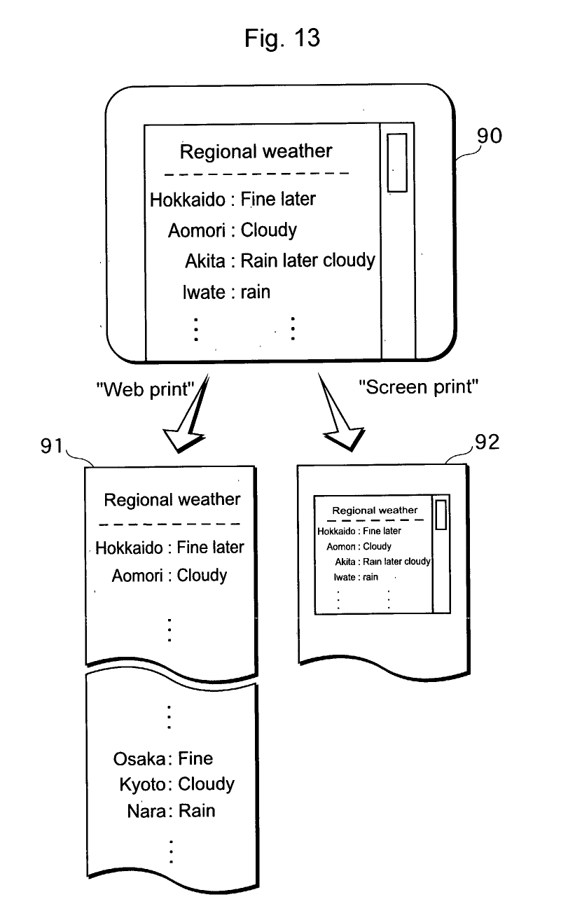

FIG. 13 shows the specific print example by the BML page sending out unit 18b of the print image generation unit 18, and here shows an example of the Web print to print the specific BML page in the received BML document data. Now, suppose that vertically oriented information 90 that cannot be contained in the screen is displayed on the display device 25. In other words, the operator can see the whole of one BML page displayed now by scrolling and displaying the screen using the up-and-down arrow buttons 29a and so forth.

When the operator pushes “Print present page” button 28b among the group of the BML gape print buttons 28, the document data of the BML page are transmitted from the digital broadcast receiver (the BML page sending out unit 18b of the print image generation unit 18) to the printer 30 (the BML interpretation unit 31b of the print control unit 31) and, at this place, are unfolded into the bit image and are printed. As a result, as the print example 91 by the “Web” print in FIG. 13 shows, the whole contents of the BML page, without depending on the display size of the display device 25, are printed. Incidentally, in the case that the operator pushes “Whole screen” button 27a of the remote control 26, the compressed image data that shows the screen image are transmitted from the digital broadcast receiver 10 (the conversion processing unit 18a of the print image generation unit 18) to the printer 30 (the image memory unit 32) and, at this place, are unfolded into the bit image and are printed. As a result, as the print example 92 by the “Screen” print in FIG. 13 shows, the same hard copy that the screen image of the display device 25 is printed.

Next, the operating characteristics of the printer 30 of the present digital broadcast printing system 1 are explained.

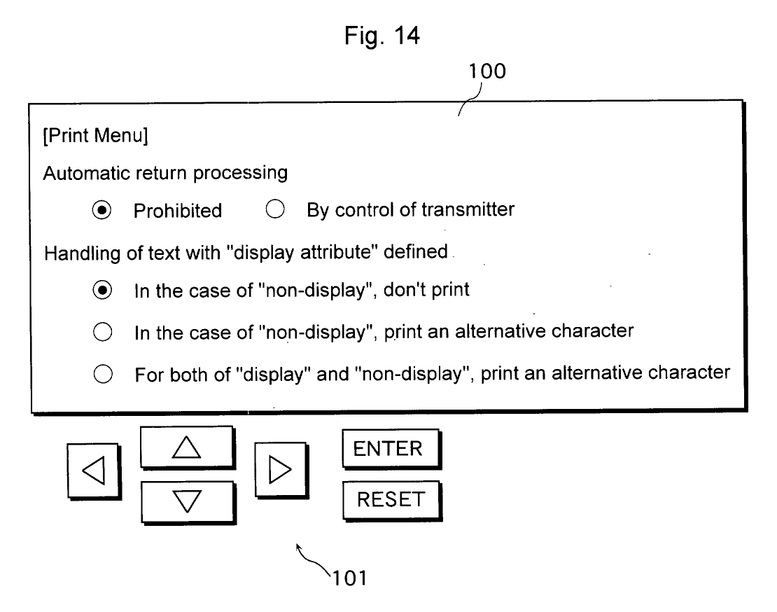

FIG. 14 is a diagram that explains the conversational function with the operator by the print condition setting unit 31a of the print control unit 31 in the printer 30, and here shows an LCD 100 and setting buttons 101.

The operator can make the specific settings for printing the digital broadcast while he/she converses with the printer 30 using the display of the LCD 100 and the setting buttons 101. To be more specific, as FIG. 14 shows, the operator can prohibit the automatic carriage return-line feed operation by the automatic return control unit 31c, and in response to the instruction of transmitter (the received BML document data) execute (or prohibit) the automatic carriage return-line feed. Additionally, the operator can specify the handling of the text in which “the display attribute (visibility)” is defined. Here, as for the text in which “the display attribute” is “non-display (hidden)”, the operator can set not to print the text, set to print an alternative character (the specified character such as “*” and so forth) and as for all the texts in which “the display attribute” is defined, the operator can set to print the alternative character.

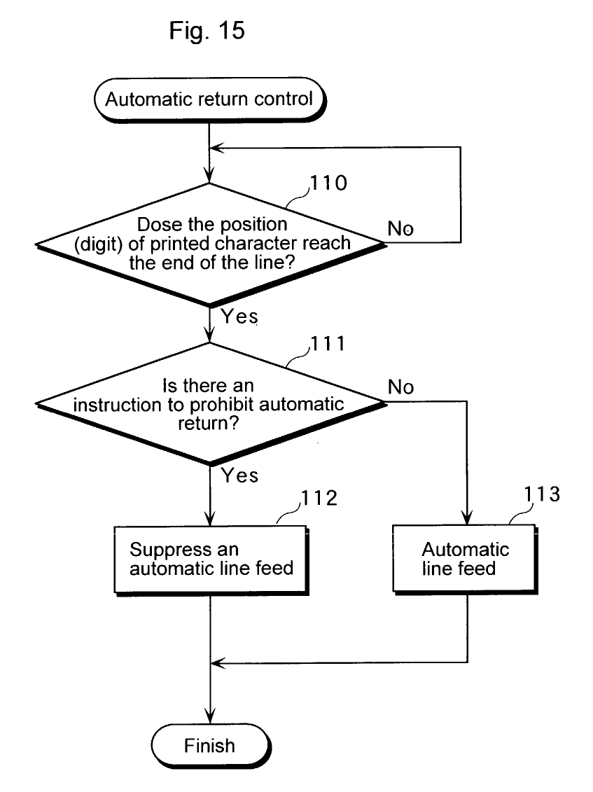

FIG. 15 is a flow chart that shows operation procedures of the automatic return control unit 31c of a printer 30. The automatic return control unit 31c monitors whether the digit number of the text that is being printed reaches the end of the line in a printing paper or not by counting the number of characters of the text data that are decoded and separated by the BML interpretation unit 31b (Step 110). When the digit number reaches the end of the line, complying with the setting contents of the return processing memorized in the print condition setting unit 31a (Step 111), the automatic return control unit 31c suppresses the automatic carriage return-line feed (Step 112), or executes the automatic carriage return-line feed (Step 113). Incidentally, in the case of suppressing the automatic carriage return-line feed, the automatic return control unit 31 does the processing that discards all the characters inputted over the digit of the end of line and does not print until the control character arrives. By doing this, inconsistency with the screen image accompanying the automatic carriage return-line feed is avoided.

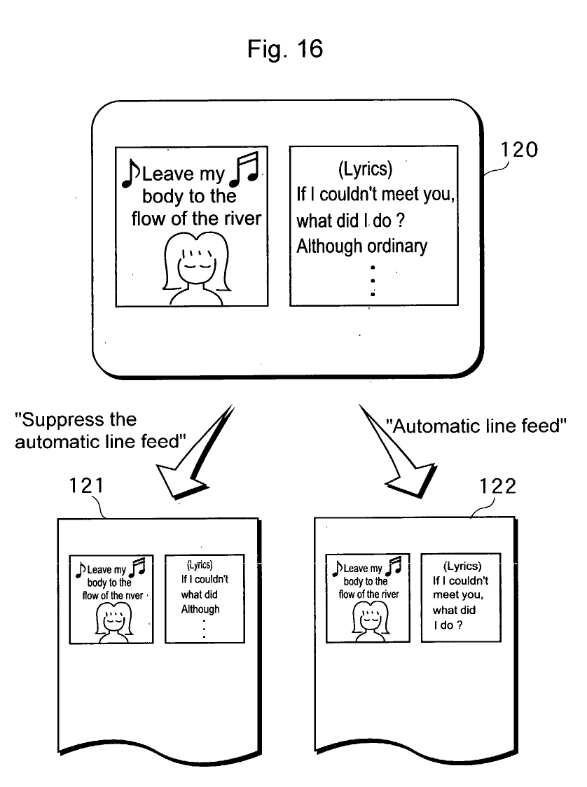

FIG. 16 is print examples by the operation of the automatic return control unit 31c like these. Here, FIG. 16 shows the display screen 120 of the text on the display device 25, a print example 121 acquired by the printer 30 with the setting that prohibits the automatic return function, and another print example 122 acquired by the printer 30 with the setting that allows the automatic return function. Incidentally, the number of characters that can be displayed in a line on the screen of the display device (the number of display digit) is larger than the number of characters that can be printed in a line of the printing paper set in the printer 30 (the number of print digit).

In the print example 121 of FIG. 16, the automatic carriage return-line feed is suppressed, and the characters located in the digits over the width of the printing paper are discarded. By doing this, the relationship between the positions of each object in right and left (the still image and the beginning part of each line of the text) on the display screen 120 is maintained in the print output. Incidentally, in this example, to stand out the difference, an extreme example is shown, in reality, in the case of printing, as there is a margin area outside of the normal printing area, in the case that the difference between the display font and the print font the printer provides is small, by printing in a margin area outside of the normal printing area, it is possible to maintain the layout and print without discarding any characters.

On the other hand, in the print example 122 of FIG. 16, since the automatic carriage return-line feed is inserted, the one-line text on the display screen 120 is printed in two lines. In this case, the relationship between the positions of each object in right and left on the display screen 120 is not in order. However, all the text is printed without being discarded.

As just described, by prohibiting the automatic return function, it is possible to acquire a hard copy that is close to the screen image on the display screen of the display device 25. On the other hand, by allowing the automatic return function, it is possible to print all the characters without discarding any of them.

Incidentally, as for the technique to match (or be in a close form with) the screen image and the print image, it is acceptable to realize by processing of a character font not by the suppression of the return processing only. For example, the print image generation unit 18 of the digital broadcast receiving device 10 does not output the character information included in the broadcast data as-is to the printer 30 but includes the actual size information (each size of length and width) of the used font (for example, the provided font (a monospaced font)) in the print data and transmit the actual size information and the print data to the printer 30. The printer 30 does not unfold the received character information by using the font data incorporated but decides the position of each character based on the informed actual size information and prints. By doing this, it is realized that the screen image matches the print image in printing the characters. Additionally, without depending on the equipment condition whether the printer is equipped with the specified font data or not, and the text is printed with the same position and size as the screen image.

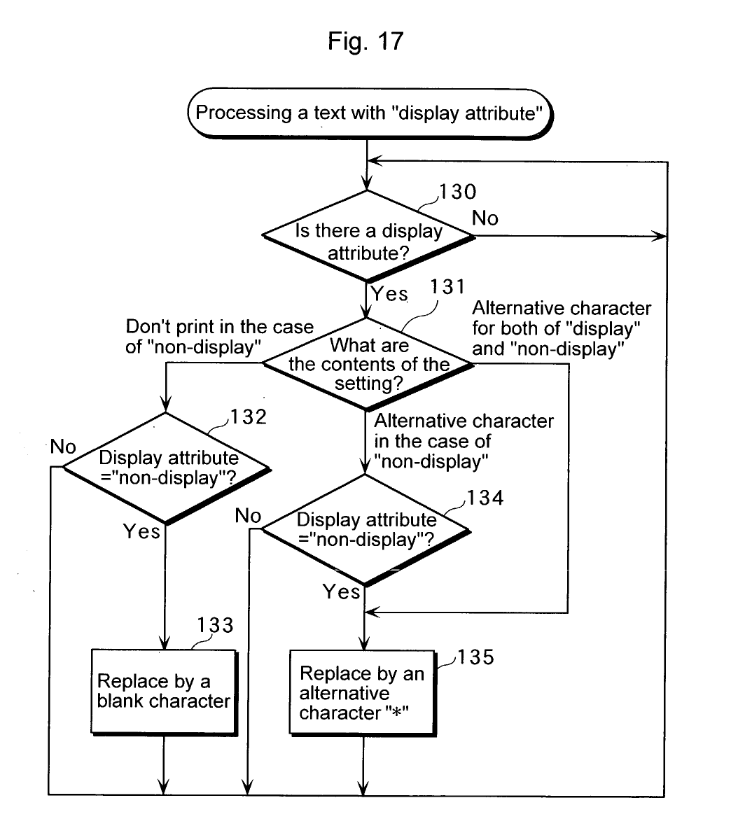

FIG. 17 is a flow chart that shows operation procedures of the display attribute control unit 31d of the print control unit 31. The display attribute control unit 31d monitors whether there is a definition sentence in the text data that are decoded and separated by the BML interpretation unit 31b or not (Step 130). In the case that the display attribute control unit 31d finds the definition sentence (Yes at Step 130), the display attribute control unit 31d refers to the setting contents memorized in the print condition setting unit 31a, namely, the setting contents on handling the text in which “the display attribute” is defined (Step 131), as a result, when the setting contents are ‘in the case that “the display attribute” is “non-display”, don't print’ (the left direction at Step 131), the display attribute control unit 31d judges whether the detected definition sentence is “non-display” or not (Step 132), only in the case of “non-display” (Yes at Step 132), the display attribute control unit 31d substitutes the object text with a blank character and has the BML interpretation unit 31b output to the image memory unit 32 (Step 133).

On the other hand, when the setting contents are ‘in the case that “the display attribute” is “non-display”, print the substitute characters’ (the directly below direction at Step 131), the display attribute control unit 31d judges whether the detected definition sentence is “non-display” or not (Step 134), only in the case of “non-display” (Yes at Step 134), the display attribute control unit 31d substitutes the object text with an alternative character (“*” and so forth) and has the BML interpretation unit 31b output to the image memory unit 32 (Step 135). Furthermore, when the setting contents are ‘print an alternative character for both of “display” and “non-display”’ (the right direction at Step 131), the display attribute control unit 31d substitutes the object text with an alternative character (“*” and so forth) and has the BML interpretation unit 31b output to the image memory unit 32 (Step 135).

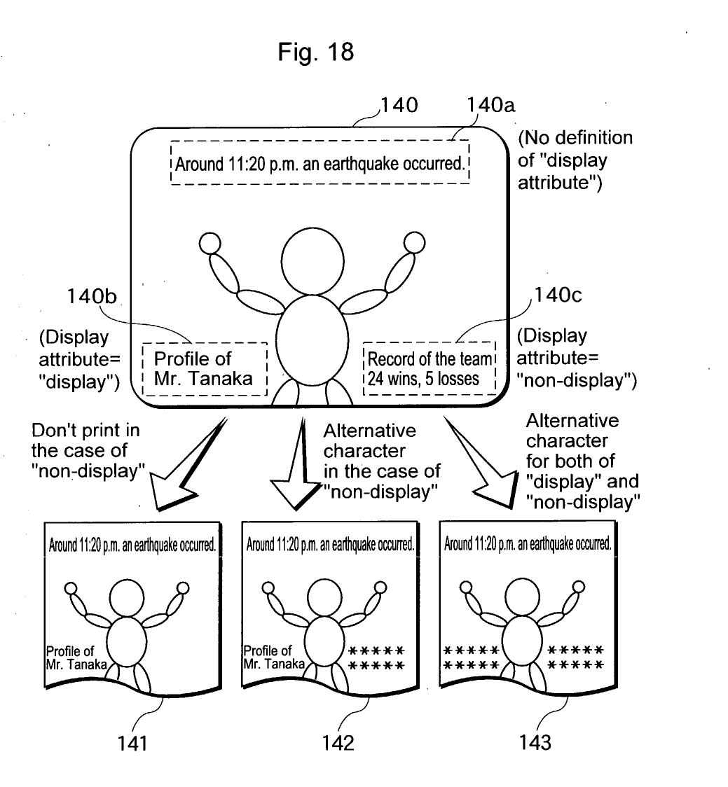

FIG. 18 is print examples by the operation of the display attribute control unit 31d like this. Now, suppose that in the upper part of the screen 140 of the display device 25, an ordinary text 140a in which “the display attribute” is not defined is displayed, and in the left lower part of the screen 140, the text 140b in which “the display attribute” is set to be “display” is displayed, and in the right lower part of the screen 140, the text 140c in which “the display attribute” is set to be “non-display” is displayed.

At this time, by using the operation buttons of the printer 30, when the operator sets that ‘in the case of “non-display”, don't print’ on ‘handling the text in which “the display attribute” is defined’, he/she can acquire the hard copy, in which only the text 140c whose “display attribute” is “non-display” is not printed (the print example 141 in FIG. 18); when the operator sets that ‘in the case of “non-display”, print the alternative character’, he/she can acquire the hard copy, in which the text 140c whose “display attribute” is “non-display” is printed with the alternative character (the print example 142 in FIG. 18); when the operator sets that ‘print an alternative character for both of “display” and “non-display”’, he/she can acquire the hard copy, in which the text 140b and the text 140c with the definition of “the display attribute” are printed with the alternative character (the print example 143 in FIG. 18).

By doing this, it is possible to print the text with the consideration of “the display attribute” in BML document data. In other words, it is possible not only to match the screen image with the print contents perfectly, but also to print with the hidden text that is not displayed on the screen indicated clearly, and to print the text displayed dynamically only in the certain condition with reliability.

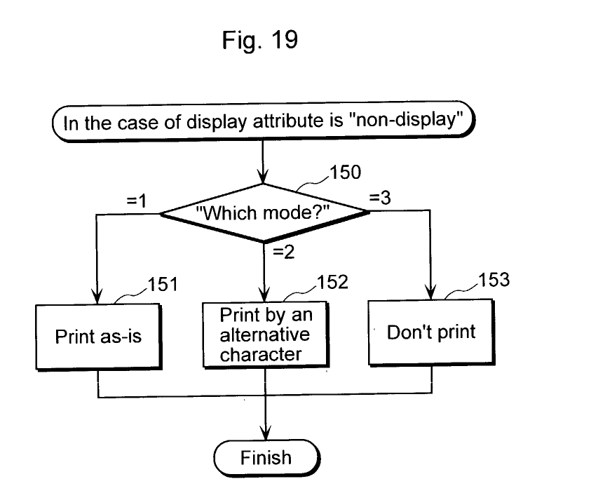

Incidentally, as for the handling (print output) of the text with the “non-display” attribute, it is acceptable to add the setting that “print as-is” to these settings. For example, as the flow chart of FIG. 19 shows, it is acceptable that the display attribute control unit 31d, in response to the mode 1˜3 that the operator has set in advance, i) prints the text with “non-display” attribute as-is, ii) prints the text with “non-display” attribute with an alternative character, or iii) does not print the text with “non-display” attribute. As a result, for example, in the case that the mode is “1”, as a screen output example 155 and a print output example 156 shows, the text with a “non-display” attribute (here, the copyright display “©1998 ABC Co., Ltd.” 157) is not displayed on the display device 25, but is outputted to the printer 30 for print. By doing this, it is possible to handle an object like the copyright display that is hidden at the time of the screen display, but becomes a print object at the time of print.

Up to this point, the digital broadcast printing system according to the present invention has been explained based on the embodiment, but this invention is not limited to this embodiment. For example, according to the present embodiment, the digital broadcast receiver 10 selects and synthesizes the display objects (the moving image, the still image, the character graphics, the subtitles, and so forth), the digital broadcast receiver 10 transmits to the printer 30 as the print data, but it is acceptable for the printer 30 to execute these selection and synthesis processing.

Additionally, it is acceptable for the various buttons of the remote control 26 to share. For example, it is acceptable to use the right and the left arrow buttons of the group of the object print buttons 29 as the alternatives to the “Back” button 28a and “Forward” button 28c of the group of the BML page print buttons 28. It is also acceptable to unity the arrow buttons 29a of the group of the object print buttons 29 with the ordinary arrow buttons to choose the menu placed the upper part of the remote control 26.

Similarly, it is acceptable to equip the remote control 26 with only one print button and for the digital broadcast receiver 10 to execute a selective print operation in response to the contents of the broadcast when the print button is pushed. For example, at the time of receiving a data broadcast, when the ordinary broadcast video is mounted into the screen of the data broadcast (additional information and so forth) and is displayed in the display device 25, and the print button is pushed, it is acceptable for the digital broadcast receiver 10 to make the video part a white frame and so forth and to output only the screen of the data broadcast selectively to be printed. By doing this, since the video screen that is an additional screen is not printed automatically, it is possible to cut down on the consumption of ink.

Moreover, the printer 30 according to the present embodiment receives two kinds of digital data, namely, the compressed image data and the BML document data, but it is acceptable to provide a port that branches an analogue image signal or a digital image signal outputted from the digital broadcast receiver 10 to the display device 25 and inputs into the printer 30 like an ordinary video printer.

Additionally, it is acceptable for the digital broadcast receiver 10 to have a function to synthesize and edit the print objects. For example, it is acceptable to store plural print objects that the operator specifies by the group of the object print buttons 29 and so forth in the storage unit 19 or the image memory unit 32 of the printer 30, and to print the plural print objects that have been stored in the aligned array or the array that the operator instructs and to print the thumbnails when the print instruction is given.

Moreover, the print engine unit 34 is not limited to the ink jet printer as long as the printer can print the image data, namely, it is acceptable for the print engine unit 34 to be the engines of a laser printer, a thermal printer, a thermal transfer printer, a dye sublimation printer and so forth.

As was stated above, by the digital broadcast printing system according to the present invention, the various styles of printing specific to the digital broadcast that is different from the general computer environment are executed with the simple operations.

In sum, a conventional printer prints the screen image superimposed and synthesized as-is, but on the other hand, the digital broadcast printing system according to the present invention can select each print objects displayed on the screen, change the layouts and the superimposed styles variously, print the video contents and the data contents in the distinguished ways, and does the flexible printing that reflects the operator's intentions.

Additionally, since the operator can select the program, specify the print objects and instruct to print by a device, especially a remote control, he/she can print the desired scenes with reliability and easily, especially in the case of a remote control, with simple operations by only one hand.

Furthermore, it is possible to maintain the layout in the screen display, and to do faithful printing that complies with the display image of the contents.

What is claimed is:

1. A digital broadcast reception device that receives a digital broadcast including video contents and data contents comprising:
a reception unit operable to receive a digital broadcast;
a separation unit operable to separate video contents and data contents from the received digital broadcast;
a video contents memorizing unit operable to memorize the separated video contents temporarily;
a data contents memorizing unit operable to memorize the separated data contents temporarily;
a screen data output unit operable to distinguish an area for displaying the video contents and an area for displaying the data contents, to synthesize the video contents memorized in the video contents memorizing unit and the data contents memorized in the data contents memorizing unit, and to generate and output screen data;
a print instruction acquisition unit operable to acquire an print instruction from an operator;
a print data output unit operable to synthesize the video contents memorized in the video memorizing unit and the data contents memorized in the data contents memorizing unit, and to generate and output print data in response to the print instruction.

2. The digital broadcast reception device according to claim 1,
wherein the print data output unit outputs only the video contents memorized in the video contents memorizing unit in response to the print instruction.

3. The digital broadcast reception device according to claim 1,
wherein the print data output unit outputs only the data contents memorized in the data contents memorizing unit in response to the print instruction.

4. The digital broadcast reception device according to claim 1 further comprising:
a print control information extraction unit to extract print control information that instructs a way of printing the contents from the received digital broadcast while the video contents and the data contents are outputted by the screen data output unit,
wherein the print data output unit outputs the video contents memorized in the video contents memorizing unit and the data contents memorized in the data contents memorizing unit selectively based on the print control information.

5. The digital broadcast reception device according to claim 1,
wherein the print instruction acquisition unit has a print control information memorizing unit that acquires print control information that instructs printing way of contents from an operator, and
the print data output unit further outputs the video contents memorized in the video contents memorizing unit and the data contents memorized in the data contents memorizing unit selectively in response to the print control information.

6. The digital broadcast reception device according to claim 1 further comprising:
a storage unit operable to store the video contents and the data contents received by the reception unit,
wherein the video contents memorizing unit memorizes the video contents read out from the storage unit temporarily, and
the data contents memorizing unit further memorizes the data contents read out from the storage unit temporarily.

7. The digital broadcast reception device according to claim 6,
wherein the print instruction acquisition unit acquires an instruction to print a representative screen of the contents stored in the storage unit from the operator, and
the print data output unit reads out the first scene of the contents from the storage unit and outputs the first scene in the case that the print instruction acquisition unit acquires the instruction to print the representative screen.

8. The digital broadcast reception device according to claim 6,
wherein the print instruction acquisition unit acquires an instruction to print plural scenes of the contents stored in the storage unit from the operator., and
the print data output unit reads out the specified scenes of the contents from the storage unit and outputs the scenes sequentially in the case that the print instruction acquisition unit acquires the instruction to print the plural scenes.

9. The digital broadcast reception device according to claim 1,
wherein the video contents memorizing unit is a frame buffer that memorizes the video contents frame by frame and
the data contents memorizing unit is a frame buffer that memorizes the data contents frame by frame.

10. A printing device that executes printing on a paper in response to print data inputted from outside comprising:
a reception unit operable to receive print data that includes a character string from outside;
a first conversion unit operable to insert a carriage return-line feed to a character string in response to a carriage return-line feed and to lay out in the case that the character string includes a carriage return-line feed;
a second conversion unit operable to insert a carriage return-line feed to a character string and lay out based on a position in a paper on which the character string is printed regardless of whether the character string includes a carriage return-line feed or not;
a print unit operable to execute the printing of the character string in response to the layouts by the first and the second conversion unit; and
a prohibiting unit operable to prohibit an operation of the second conversion unit in a predetermined case.

11. The printing device according to claim 10,
wherein the prohibiting unit prohibits the operation of the second conversion unit based on an instruction from the operator or control information of the print data.

12. The printing device according to claim 10,
wherein the print data includes actual size information that shows the size of each character included in the character string, and
the print unit decides the position of each character based on the actual size information and prints each character.

13. The printing device according to claim 12,
wherein the actual size information shows the length and the width of each character in a monospaced font, and
the print unit decides the position of each character depending only on the actual size information without depending on the size of characters that the font data, which the printing device has, shows.

14. A digital broadcast reception device that receives a digital broadcast and outputs print data comprising:
a broadcast reception unit operable to receive a digital broadcast;
a tuner unit operable to select a desired channel from the received digital broadcast;
a video formation unit operable to form video information by taking out video of the selected channel from the digital broadcast;
a print data output unit operable to output the formed video as print data;
a tuning button that instructs the tuner unit which channel should be selected; and
a print button that instructs the print data output unit to output.

15. The digital broadcast reception device according to claim 14,
wherein the tuning button and the print button are provided in one remote control for remote operation.

16. The digital broadcast reception device according to claim 15,
wherein the digital broadcast includes video contents, data contents, and print control information, and
the print data output unit, in the case of acquiring an instruction from the print button, in response to the print control information, executes either of the following: (i) to output video contents and data contents as print data; (ii) to output video contents only as print data; (iii) to output data contents only as print data.

17. A digital broadcast reception device that receives a digital broadcast and outputs print data comprising:
a broadcast reception unit operable to receive a digital broadcast;
a storage unit operable to store video from the received digital broadcast;
a screen formation unit operable to form screen information from the stored video;
a screen selection unit operable to select one screen from the formed screen information;
a print data output unit operable to output the selected screen as print data; and
a remote control that includes a screen selection button that instructs the screen selection unit which screen should be selected and a print button that instructs the print data output unit to output.

18. The digital broadcast reception device according to claim 17,
wherein the remote control further has a transition button that instructs to transition continuous video in back-and-forth direction, and
the screen selection unit skips screens of predetermined condition.

19. A printing device that executes printing on paper in response to print data inputted from outside comprising:
a reception unit operable to receive print data including a text with a screen display attribute from outside;
a memorizing unit operable to memorize the received text and the screen display attribute;
a print instruction acquisition unit operable to acquire a print instruction; and
a print unit operable to read out the text and the screen display from the memorizing unit when the print instruction acquisition unit acquires a print instruction, to output and to print the read out text based on the screen display attribute of the text.

20. The printing device according to claim 19,
wherein the print unit does not print the part of a text with the screen display attribute in the case that the screen display attribute is “non-display”.

21. The printing device according to claim 19,
wherein the print unit prints the part of a text with the screen display attribute with an alternative character in the case that the screen display attribute is “non-display”.

22. The printing device according to claim 19,
wherein the print unit prints the part of a text to which the screen display attribute is added with an alternative character.

23. 1. A digital broadcast reception method that receives a digital broadcast including video contents and data contents including:
a reception step for receiving a digital broadcast;
a separation step for separating video contents and data contents from the received digital broadcast;
a video contents memorizing step for memorizing the separated video contents temporarily;
a data contents memorizing step for memorizing the separated data contents temporarily;
a screen data output step for distinguishing an area that displays the video contents and an area that displays the data contents, for synthesizing the video contents memorized in the video contents memorizing unit and the data contents memorized in the data contents memorizing unit, and for generating and output screen data;
a print instruction acquisition step for acquiring an print instruction from an operator;
a print data output step for synthesizing the video contents memorized in the video memorizing unit and the data contents memorized in the data contents memorizing unit, and for generating and outputting print data in response to the print instruction.

24. A print method for executing printing on a paper in response to print data inputted from outside including:
a reception step for receiving print data that includes a character string from outside;
a first conversion step for inserting a carriage return-line feed to a character string in response to a carriage return-line feed and for laying out in the case that the character string includes a carriage return-line feed;
a second conversion step for inserting a carriage return-line feed to a character string and for laying out based on a position in a paper on which the character string is printed regardless of whether the character string includes a carriage return-line feed character or not;
a print step for executing the printing of the character string in response to the layouts by the first and the second conversion unit; and
a prohibiting step for prohibiting an operation of the second conversion unit in a predetermined case.

25. A digital broadcast reception method for receiving a digital broadcast and outputs print data including:
a broadcast reception step for receiving a digital broadcast;
a channel selection step for selecting a desired channel from the received digital broadcast;
a video formation step for forming video information by taking out video of the selected channel from the digital broadcast;
a print data output step for outputting the formed video as print data;
a step for instructing a selected channel by a selection button in the print data output step; and
a step for instructing print by a print button in the print data output step.

26. A digital broadcast reception method for receiving a digital broadcast and outputs print data including:
a broadcast reception step for receiving a digital broadcast;
a storage step for storing video from the received digital broadcast;
a screen formation step for forming screen information from the stored video;
a screen selection step for selecting one screen from the formed screen information;
a print data output step for outputting the selected screen as print data;
a step for instructing a screen to be selected by a screen selection button in the screen selection step; and
a step for instructing print by a print button of a remote control in the print data output step.

27. A print method for executing printing on paper in response to print data inputted from outside including:
a reception step for receiving print data including a text with a screen display attribute from outside;
a storage step for storing the received text and the screen display attribute in the memorizing unit;
a print instruction acquisition step for acquiring a print instruction; and
a print step for reading out the text and the screen display from the memorizing unit when the a print instruction is acquired, for outputting and for printing the read out text based on the screen display attribute of the text.

28. A program for a digital broadcast reception device that receives a digital broadcast including video contents and data contents including:
a reception step for receiving a digital broadcast;
a separation step for separating video contents and data contents from the received digital broadcast;
a video contents memorizing step for memorizing the separated video contents temporarily;
a data contents memorizing step for memorizing the separated data contents temporarily;
a screen data output step for distinguishing an area that displays the video contents and an area that displays the data contents, for synthesizing the video contents memorized in the video contents memorizing unit and the data contents memorized in the data contents memorizing unit, and for generating and output screen data;
a print instruction acquisition step for acquiring an print instruction from an operator;
a print data output step for synthesizing the video contents memorized in the video memorizing unit and the data contents memorized in the data contents memorizing unit, and for generating and outputting print data in response to the print instruction.

29. A program for a printing device that executes printing on a paper in response to print data inputted from outside including:
a reception step for receiving print data that includes a character string from outside;
a first conversion step for inserting a carriage return-line feed to a character string in response to a carriage return-line feed character and for laying out in the case that the character string includes a carriage return-line feed character;
a second conversion step for inserting a carriage return-line feed to a character string and for laying out based on a position in a paper on which the character string is printed regardless of whether the character string includes a carriage return-line feed character or not;
a print step for executing the printing of the character string in response to the layouts by the first and the second conversion unit; and
a prohibiting step for prohibiting an operation of the second conversion unit in a predetermined case.

30. A program for a digital broadcast reception device that receives a digital broadcast and outputs print data including:
a broadcast reception step for receiving a digital broadcast;
a channel selection step for selecting a desired channel from the received digital broadcast;
a video formation step for forming video information by taking out video of the selected channel from the digital broadcast;
a print data output step for outputting the formed video as print data;
a step for instructing a selected channel by a selection button in the print data output step; and
a step for instructing print by a print button in the print data output step.

31. A program for a digital broadcast reception device that receives a digital broadcast and outputs print data including:
a broadcast reception step for receiving a digital broadcast;
a storage step for storing video from the received digital broadcast;
a screen formation step for forming screen information from the stored video;
a screen selection step for selecting one screen from the formed screen information;
a print data output step for outputting the selected screen as print data;
a step for instructing a screen to be selected by a screen selection button in the screen selection step; and
a step for instructing print by a print button of a remote control in the print data output step.

32. A program for a printing device that executes printing on paper in response to print data inputted from outside including:
a reception step for receiving print data including a text with a screen display attribute from outside;
a storage step for storing the received text and the screen display attribute in the memorizing unit;
a print instruction acquisition step for acquiring a print instruction; and
a print step for reading out the text and the screen display from the memorizing unit when the a print instruction is acquired, for outputting and for printing the read out text based on the screen display attribute of the text.
